(19) United States
(12) Patent Application Publication
(10) Pub. No.: US 2019/0019025 A1
(43) Pub. Date: Jan. 17, 2019

(54) IMAGE PICKUP APPARATUS,AUTHENTICATION APPARATUS, AND IMAGE PICKUP METHOD

(71) Applicant: SHARP KABUSHIKI KAISHA, Sakai City (JP)

(72) Inventors: SHINOBU YAMAZAKI, Sakai City (JP); TAKASHI NAKANO, Sakai City (JP); YUKIO TAMAI, Sakai City (JP); DAISUKE HONDA, Sakai City (JP)

(21) Appl. No.: 16/032,479

(22) Filed: Jul. 11, 2018

(30) Foreign Application Priority Data
Jul. 14, 2017 (JP) 2017-138368

(51) Int. Cl. G06K 9/00; G06F 1/16; G02B 5/30; H04N 5/225; G06F 21/32

(52) U.S. Cl. CPC G06K 9/00617; G06F 1/1605; G06F 21/32; G06K 9/00604; H04N 5/2252; G02B 5/3025

(57) ABSTRACT

A mobile information terminal includes an emitted-light polarizing filter having a transmission axis in a first direction, a received-light polarizing filter having a transmission axis in a second direction, an infrared light source emitting near infrared light through the emitted-light polarizing filter, and an image pickup section receiving reflected light generated when the near infrared light is reflected off an object, through the received-light polarizing filter. The second direction has such an angle determined with respect to the first direction that the received-light polarizing filter blocks at least part of light having a polarization property in the reflected light.

### CROSS-REFERENCE TO RELATED APPLICATIONS

This application claims the benefit of priority to Japanese Patent Application Number 2017-138368 filed on Jul. 14, 2017. The entire contents of the above-identified application are hereby incorporated by reference.

### BACKGROUND

### Technical Field

The disclosure described below relates to an image pickup apparatus taking an image of an iris, an authentication apparatus including the image pickup apparatus, and an image pickup method.

Mobile information terminals, such as smartphones, have recently been developed that have functions to perform personal biometric authentication using iris information on an eye of a user (iris authentication). In this iris authentication, near infrared light is radiated to an eyeball of the user, an iris image formed by reflected light reflected off the eyeball is taken, and authentication is performed. Near infrared light is used because, with visible light, pigment of an iris hinders a clear iris image from being obtained.

When near infrared light is radiated to an eye, light is reflected off the cornea or the like of the eye in a specularly reflected manner, and the light source is reflected in the iris image in some cases. Iris authentication with the iris image in which the light source is reflected may cause a problem that the authentication takes time or that the authentication fails.

JP 2005-304809 A (published on Nov. 4, 2005) discloses an image capturing apparatus that turns on a plurality of illuminating devices having different distances with respect to the optical axis of an iris capturing camera sequentially in the order of proximity to the optical axis and that analyzes an image obtained by a capturing unit at each timing of turning on the illuminating devices. This image capturing apparatus takes eye images illuminated by the illuminating devices performing such illumination as to prevent reflection of reflected light of illuminating light in the iris.

JP 2004-172951 A (published on Jun. 17, 2004) discloses an image pickup device for monitoring a vehicle number, that includes an illumination side polarizing plate and an image pickup side polarizing plate. Illumination light passes through the illumination side polarizing plate and is linearly polarized. The linearly polarized illumination light is reflected off a number plate, and specular reflection components of the reflected light are blocked by the image pickup side polarizing plate.

JP 2007-181676 A (published on Jul. 19, 2007) discloses a system that can perform illumination with switchable unpolarized and polarized beams and can move a plurality of light sources relatively to reduce the intensity of reflected light having a negative impact on operation (such as surgery) of a user.

### SUMMARY

To take a clear iris image under various circumstances with reduced effect of reflected light, it is desirable to radiate near infrared light from the front of the eyeball with a light source (near infrared light illuminator) and to take an image of an iris from the front with an iris capturing camera.

Unfortunately, the aforementioned small information device, such as a smartphone, has size limitation and is assumed to take an iris image from a relatively short distance. It is thus difficult to radiate near infrared light from the front of an eyeball and to take an image with an iris capturing camera disposed on the same optical axis of the near infrared light. This indicates that image pickup and iris authentication are performed with the eyeball of the user shifted in position from the light source and the iris capturing camera.

In this case, a problem may arise that the radiated near infrared light is reflected off the cornea, a contact lens, or a lens of glasses, and the light source is reflected in the iris image. This problem is more serious when the user wears glasses. This is because of the following reason. A lens of glasses is close to a flat surface in comparison with a cornea and the like, so that most of light reflected off the surface of the lens travels toward the camera. This increases the area of the region where the light source overlaps the iris in the iris image.

The apparatus disclosed in JP 2005-304809 A (published on Nov. 4, 2005) includes the illuminating devices, so that manufacturing cost increases with an increase in the number of components and an increase in system complexity. The apparatus sequentially turns on the illuminating devices and checks each of the obtained images for a reflected image, and processing is thus assumed to take a long time. In some cases, the reflected image of the light source may have an adverse effect on iris authentication.

The device disclosed in JP 2004-172951 A (published on Jun. 17, 2004) is assumed to be disposed facing a number plate at such a distance from the number plate that the optical axis of radiation light substantially coincides with the optical axis of reflected light. Thus, this device cannot be applied to a device in which the optical axis of radiation light is not assumed to coincide with the optical axis of reflected light.

The system in JP 2007-181676 A (published on Jul. 19, 2007) has a mechanism that moves light sources, resulting in an increase in complexity and an increase in size.

An object of an aspect of the present disclosure is to provide an image pickup apparatus capable of taking an iris image with reduced reflection of a light source with a simple configuration, and an authentication apparatus including the image pickup apparatus.

To solve the above problem, an image pickup apparatus according to an aspect of the present disclosure includes: a first polarizing element having a transmission axis in a first direction; a second polarizing element having a transmission axis in a second direction different from the first direction; a light source configured to emit near infrared light through the first polarizing element; and a light-receiving element configured to receive reflected light generated upon reflection of the near infrared light off an object, through the second polarizing element. The second direction has such an angle determined with respect to the first direction that the second polarizing element blocks at least part of light having a polarization property in the reflected light.

An image pickup apparatus according to an aspect of the present disclosure includes: first polarizing elements of a plurality of types having transmission axes in mutually different directions; a light source configured to emit near infrared light through the first polarizing elements; second polarizing elements of a plurality of types having transmission axes in directions corresponding to the directions of the transmission axes of the first polarizing elements; and a light-receiving element configured to receive reflected light generated upon reflection of the near infrared light off an object, through the second polarizing elements. The directions of the transmission axes of the second polarizing elements have such angles determined with respect to the directions of the transmission axes of the first polarizing elements that the second polarizing element of any one of the types blocks at least part of light having a polarization property in the reflected light.

To solve the above problem, an image pickup method according to an aspect of the present disclosure takes an iris image with an image pickup apparatus including a light source configured to emit near infrared light and a light-receiving element configured to receive reflected light generated upon reflection of the near infrared light off an object. The image pickup method includes: emitting the near infrared light through a first polarizing element having a transmission axis in a first direction; and receiving the reflected light through a second polarizing element having a transmission axis in a second direction different from the first direction. The second direction has such an angle determined with respect to the first direction that the second polarizing element blocks at least part of light having a polarization property in the reflected light.

An aspect of the present disclosure exhibits effect of providing an image pickup apparatus capable of taking an iris image with reduced reflection of a light source with a simple configuration, and an authentication apparatus including the image pickup apparatus.

### BRIEF DESCRIPTION OF DRAWINGS

The disclosure will be described with reference to the accompanying drawings, wherein like numbers reference like elements.

FIG. 1A is a front view of an external structure of a mobile information terminal according to Embodiment 1 of the present disclosure, and FIG. 1B is an enlarged view of a main portion.

FIG. 2 is a schematic view of a configuration of the mobile information terminal.

FIG. 3A is a diagram for describing the incident plane and reflective plane of polarized light and polarization direction, and FIG. 3B is a schematic view for describing a positional relationship among an infrared light radiation section, a lens, and a light-receiving section, and reflection and block of polarized light.

FIG. 4 is a schematic view of an image taken with the mobile information terminal.

FIG. 5 is an enlarged view of a main portion of a mobile information terminal according to Embodiment 2 of the present disclosure.

FIG. 6A is a side view of the state of taking an iris image with an iris authentication device according to Embodiment 4 of the present disclosure, and FIG. 6B is an enlarged view of a main portion.

FIG. 7 is a schematic view of a configuration of the iris authentication device.

FIGS. 8A to 8C are diagrams for describing removal of specularly-reflected light in the iris authentication device, FIG. 8A is a front view of the iris authentication device, FIG. 8B is an enlarged view of a polarizing unit, and FIG. 8C is a diagram for describing an example rule for extracting a pixel representative value.

FIG. 9A is a schematic view of an image taken with an iris authentication device according to Comparative Example that does not remove specularly-reflected light, and FIG. 9B is a schematic view of an image taken with the iris authentication device according to the embodiment.

FIG. 10A is a plan view schematically illustrating paths of various types of light and FIG. 10B is a schematic view illustrating reflection of a light source in a displayed image, when an image pickup apparatus of Comparative Example takes an image of an iris of a user wearing glasses.

### DESCRIPTION OF EMBODIMENTS

Embodiments of the present disclosure will be described below. Note that the shapes and dimensions (length, depth, width, and the like) of the configurations illustrated in the drawings of the present application are not based on the practical shapes and dimensions, and are modified as appropriate to clarify and simplify the drawings.

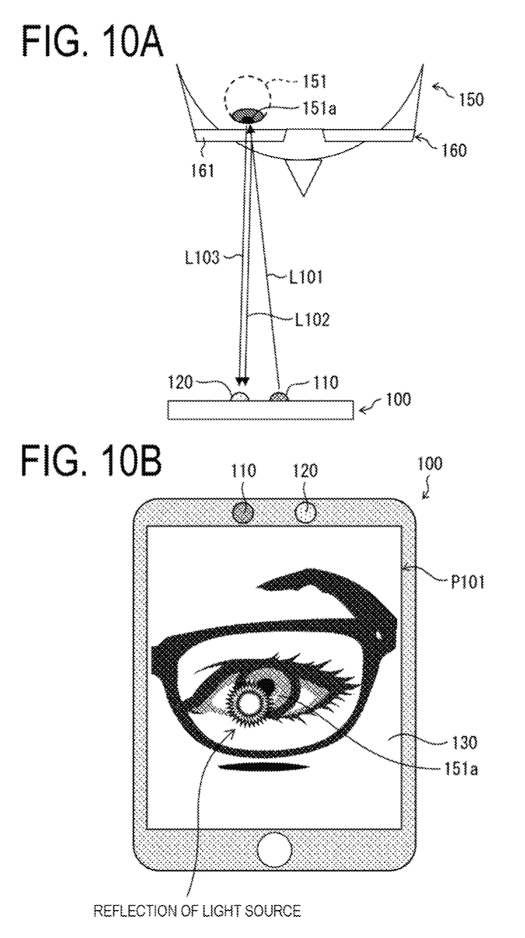

First, to facilitate understanding of an image pickup apparatus and the like according to embodiments of the present disclosure, the phenomenon of reflection of a light source that may occur in iris authentication of a user (a person to be authenticated) wearing glasses will be described with reference to FIGS. 10A and 10B illustrating an image pickup apparatus, configured as a smartphone being a small information device, of Comparative Example. FIG. 10A is a plan view schematically illustrating paths of various types of light and FIG. 10B is a schematic view illustrating reflection of a light source in a displayed image, when the image pickup apparatus of Comparative Example takes an image of an iris of a user wearing glasses.

As illustrated in FIGS. 10A and 10B, an image pickup apparatus 100 of Comparative Example includes an infrared light source 110 radiating near infrared light L101, an iris capturing camera 120 receiving reflected light of the radiated near infrared light L101 and taking an image, and a display section 130 displaying the image. The user 150 wears glasses 160.

In a case where the user 150 holds the image pickup apparatus 100 of Comparative Example in front of the face of the user 150 at a relatively short distance from the face and takes an image of the iris of an eyeball 151 of the user 150 with the image pickup apparatus 100, the following happens.

One portion of the near infrared light L101 emitted from the infrared light source 110 is reflected off a lens 161 of the glasses 160, and another portion passes through the lens 161. The near infrared light L101 passing through the lens 161 is radiated to the eyeball 151 of the user 150. Near infrared light L102 reflected off the lens 161 in a specularly reflected manner is incident on the iris capturing camera 120. Near infrared light L103 passing through the lens 161 and reflected off the eyeball 151 partially passes through the lens 161 and is incident on the iris capturing camera 120.

As illustrated in FIG. 10A, in the image pickup apparatus 100 of Comparative Example, the optical axis of the radiation light (near infrared light L101) is not assumed to coincide with the optical axes of the reflected light (near infrared light L102, L103). In other words, (i) the direction in which the near infrared light L101 emitted from the infrared light source 110 travels toward the eyeball 151, and (ii) the direction in which the reflected light reflected off the eyeball 151 or the lens 161 travels toward the iris capturing camera 120 are not assumed to be mutually opposite directions on the same straight line.

The iris capturing camera 120 receives the near infrared light L102 and the near infrared light L103, so that the infrared light source 110 may be reflected in an image P101 displayed on the display section 130. The near infrared light L102 is light reflected off the lens 161 in a specularly reflected manner. Thus, the reflection of the infrared light source 110 often appears on an iris 151a in the image P101. Such an iris image is undesirable because it is highly likely that iris authentication is not performed normally. Specifically, a problem may arise that iris authentication takes long time or that authentication fails.

To prevent this problem, the user 150 is required to take off the glasses 160 and perform authentication again, which is a forced troublesome operation taking time of the user 150. Iris authentication is used for unlocking a lock screen of a smartphone or the like in some cases, and requirement of the above-described operation of taking off the glasses 160 thus significantly decreases convenience of the user 150.

In a case where the user 150 wears contact lenses instead of the glasses 160, or a case where the near infrared light L101 is reflected off the cornea of the eyeball 151, the above-described problem of reflection of the light source may occur similarly.

The above-described reflection of a light source can be removed through arithmetic processing; however, time and power consumption are required for the arithmetic processing. It is therefore very useful to solve the above-described problem with the simplest possible configuration.

The inventors have focused on this problem (found the problem) and have diligently conducted review to solve the problem. As a result, an image pickup apparatus and the like according to the embodiments of the present disclosure have been arrived at on the basis of a novel idea.

### Embodiment 1

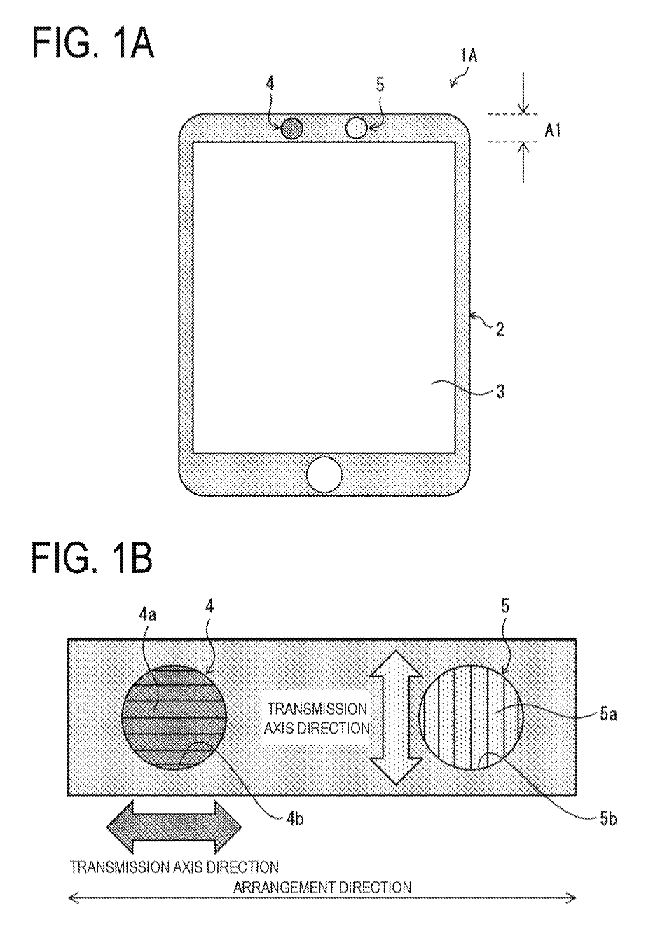

An embodiment of the present disclosure will be described below with reference to FIGS. 1A to 4.

Note that in the present embodiment, an image pickup apparatus and an authentication apparatus mounted in a mobile information terminal, such as a smartphone, for example, are described, but should not be construed to limit an image pickup apparatus and an authentication apparatus according to the present disclosure. For example, the image pickup apparatus and the authentication apparatus may be mounted in a camera type device used for iris authentication. Alternatively, the image pickup apparatus and the authentication apparatus may be mounted in, for example, a device connected with a mobile information terminal in a communicable manner and adding a function of iris authentication. Especially the image pickup apparatus and the like of the present disclosure can be suitably applied to a small information device, such as a mobile terminal, in which the optical axis of radiation light does not coincide with the optical axis of reflected light.

A mobile information terminal 1A of the present embodiment is a smartphone having a function to radiate near infrared light to an eyeball of a person and to take an image of an iris to perform iris authentication. Even in the case where a user wears glasses, for example, the mobile information terminal 1A can take an iris image with reduced reflection of a light source.

### Configuration of Mobile Information Terminal 1A

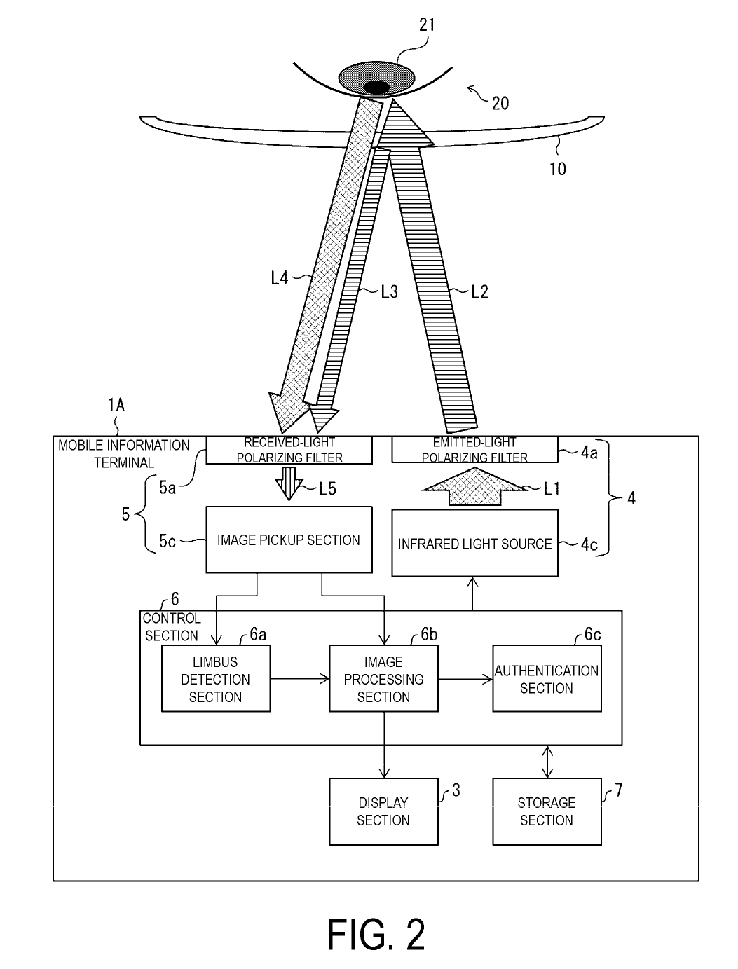

A configuration of the mobile information terminal 1A including the image pickup apparatus and the authentication apparatus of the present embodiment will be described with reference to FIGS. 1A to 2. FIG. 1A is a front view of an external structure of the mobile information terminal 1A of the present embodiment, and FIG. 1B is an enlarged view of a main portion. FIG. 2 is a schematic view of a configuration of the mobile information terminal 1A. In the following description, the side where a user performs operations on the mobile information terminal 1A (the side having a display surface) is referred to as a front surface.

### External Structure

As illustrated in FIGS. 1A and 1B, the mobile information terminal 1A includes a terminal body 2 being a housing, a display section 3 disposed occupying a major area of a front surface of the terminal body 2 and displaying an image, an infrared light radiation section 4, and a light-receiving section 5. The infrared light radiation section 4 and the light-receiving section 5 are disposed in an upper frame region A1 in an aligned manner. The upper frame region A1 is located between the outer edge of the rectangular terminal body 2 and the display section 3 on the front surface of the terminal body 2 and above the display section 3 in an orientation where the user uses the mobile information terminal 1A normally.

The terminal body 2 may be made from a material similar to that of a typical mobile information terminal and may have a shape similar to that of a typical mobile information terminal. Similarly, the display section 3 may have a configuration similar to that of a typical mobile information terminal. For example, the display section 3 is a liquid crystal panel. The display section 3 may be a display panel of another type (such as an organic EL panel).

In the terminal body 2, an emitting hole 4b from which near infrared light is emitted and an incident hole 5b on which external light is incident to enter the mobile information terminal 1A are formed. The infrared light radiation section 4 includes the emitting hole 4b, and the light-receiving section 5 includes the incident hole 5b.

The emitting hole 4b of the infrared light radiation section 4 is provided with an emitted-light polarizing filter 4a being a first polarizing element. The incident hole 5b of the light-receiving section 5 is provided with a received-light polarizing filter 5a being a second polarizing element.

Each of the emitted-light polarizing filter 4a and the received-light polarizing filter 5a is a polarizing element forming linearly polarized light from desired light and corresponding to the wavelength of near infrared light. Such a polarizing element having a transmission axis in a prescribed direction and forming linearly polarized light is also called “polarizer”.

The emitted-light polarizing filter 4a and the received-light polarizing filter 5a may be any linear polarizer having a transmission axis in a prescribed direction, and the specific configuration (type and the like) thereof is not particularly limited. For example, the polarizing filters may be wire-grid polarizers in which a fine metallic grid is formed to have slits or absorptive polarizers, such as sheet-type resin polarizers. Polarizers of other types may be used.

Herein, the emitted-light polarizing filter 4a and the received-light polarizing filter 5a are configured as wire-grid polarizers. Note that the lines drawn on each of the emitted-light polarizing filter 4a and the received-light polarizing filter 5a in FIG. 1B indicate a transmission axis direction, and the grid is formed while being aligned in a direction orthogonal to the transmission axis direction.

The emitted-light polarizing filter 4a covers the emitting hole 4b. Thus, the near infrared light emitted from the mobile information terminal 1A is linearly polarized in the transmission axis direction of the emitted-light polarizing filter 4a. The received-light polarizing filter 5a covers the incident hole 5b. Thus, light having a polarization component in the transmission axis direction of the received-light polarizing filter 5a in light incident on the mobile information terminal 1A passes through the received-light polarizing filter 5a.

Herein, the emitted-light polarizing filter 4a and the received-light polarizing filter 5a are disposed in the terminal body 2. Note that the emitted-light polarizing filter 4a and the received-light polarizing filter 5a may be disposed respectively in the emitting hole 4b and the incident hole 5b. Alternatively, the emitted-light polarizing filter 4a and the received-light polarizing filter 5a may be resin polarizers or the like attached externally on the surface of the terminal body 2, which will be described in detail later in Embodiment 3.

A protective material (not illustrated) made from plastic or the like and transmitting near infrared light is formed on the front surface side of each of the emitted-light polarizing filter 4a and the received-light polarizing filter 5a.

The infrared light radiation section 4 and the light-receiving section 5 are arranged in an arrangement direction D1 in the upper frame region A1 on the front surface of the terminal body 2. The emitted-light polarizing filter 4a and the received-light polarizing filter 5a are aligned in this arrangement direction D1 in a front view of the mobile information terminal 1A. More specifically, the arrangement direction D1 is the direction of the straight line connecting the center point of the emitting hole 4b and the center point of the incident hole 5b.

In the mobile information terminal 1A of the present embodiment, the emitting hole 4b and the incident hole 5b have substantially the same diameter. However, the emitting hole 4b and the incident hole 5b may have mutually different diameters. Even in this case, the arrangement direction D1 can be identified as described above.

In the mobile information terminal 1A of the present embodiment, the emitted-light polarizing filter 4a has a transmission axis in a direction parallel with the arrangement direction D1 (transmission axis in a first direction). In other words, the emitted-light polarizing filter 4a is disposed at the emitting hole 4b with the transmission axis extending in the direction parallel with the arrangement direction D1.

The received-light polarizing filter 5a has a transmission axis in a direction orthogonal to (at an angle of 90° with respect to) the arrangement direction D1 (transmission axis in a second direction). In other words, the received-light polarizing filter 5a is disposed at the incident hole 5b with the transmission axis extending in the direction orthogonal to the arrangement direction D1.

Action and effect of the emitted-light polarizing filter 4a and the received-light polarizing filter 5a having transmission axes in these directions will be described in detail later.

### Internal Configuration and Emission and Incidence of Light

Next, an internal configuration of the mobile information terminal 1A of the present embodiment will be described with reference to the block diagram in FIG. 2, and emitted light and incident light in taking an iris image will be described.

As illustrated in FIG. 2, the mobile information terminal 1A includes the infrared light radiation section 4, the light-receiving section 5, a control section 6, the display section 3, and a storage section 7. The infrared light radiation section 4 and the light-receiving section 5 constitute the image pickup apparatus of the present embodiment, and the image pickup apparatus and the control section 6 constitute the authentication apparatus of the present embodiment. The mobile information terminal 1A includes the image pickup apparatus and the authentication apparatus of the present embodiment. The infrared light radiation section 4 may also be called a near infrared light source with a polarizing filter, and the light-receiving section 5 may also be called an iris capturing camera with a polarizing filter.

The infrared light radiation section 4 includes the emitted-light polarizing filter 4a and an infrared light source 4c emitting near infrared light. The infrared light source 4c emits near infrared light through the emitted-light polarizing filter 4a. The infrared light source 4c is, for example, a light emitting diode (LED) emitting near infrared light.

Herein, the term “near infrared light” refers to light of a wavelength in the near infrared range, and preferably light having a peak wavelength in the near infrared wavelength range. The near infrared wavelength range is from 700 nm to 1100 nm. This is the range of wavelengths of near infrared light that can be detected by a typically used silicon image pickup device. With an image pickup device having sensitivity to longer wavelengths than the silicon image pickup device, the infrared light source 4c may emit light of a wavelength longer than 1100 nm.

The infrared light source 4c may be of any type that can radiate light of a wavelength that can be used for iris authentication, and the specific configuration of the infrared light source 4c is not particularly limited. For example, the infrared light source 4c may be a lamp radiating near infrared light. Furthermore, the infrared light source 4c is only required to emit light at least partially having such intensity that an image pickup section 5c can detect it as light in the near infrared wavelength range, and may emit infrared light having a peak wavelength longer than wavelengths in the near infrared range.

The light-receiving section 5 includes the received-light polarizing filter 5a and the image pickup section 5c receiving light. The image pickup section 5c receives reflected light generated when near infrared light emitted from the mobile information terminal 1A is reflected off an object, through the received-light polarizing filter 5a. The image pickup section 5c functions as a near infrared camera and an iris capturing camera.

The image pickup section 5c takes an image composed of a plurality of pixels arranged two-dimensionally. The image pickup section 5c is, for example, a charge coupled device (CCD) image sensor or a complementary metal oxide semiconductor (CMOS) image sensor. Herein, the image pickup section 5c composed of a CCD image sensor is exemplified in the description.

The control section 6 is composed of an arithmetic processing unit (not illustrated), such as a central processing unit (CPU) and a dedicated processor, and a memory component (not illustrated), such as a random access memory (RAM), a read only memory (ROM), and a hard disc drive (HDD), and reads out various pieces of information and programs for various types of control stored in the memory component and executes the programs.

The control section 6 comprehensively controls operations of each of the components of the mobile information terminal 1A.

The control section 6 includes a limbus detection section 6a, an image processing section 6b, and an authentication section 6c.

The limbus detection section 6a acquires a near infrared image taken by the image pickup section 5c with the CCD image sensor and identifies a region corresponding to a limbus of the user in the infrared image. Processing at the limbus detection section 6a is known in the field of authentication with an iris image, for example, and descriptions thereof will be omitted in the present specification. Note that the limbus detection section 6a may be achieved as one function of the image processing section 6b. In this case, the limbus detection section 6a is contained in the image processing section 6b.

The image processing section 6b uses the near infrared image taken by the image pickup section 5c and information on the region corresponding to the limbus of the user received from the limbus detection section 6a to perform image processing and generates an iris image. Data of the generated iris image is displayed on the display section 3 and transmitted to the authentication section 6c.

The authentication section 6c uses the iris image generated through data processing at the image processing section 6b to perform iris authentication of the user.

Processing at the image processing section 6b and the authentication section 6c is also known in the field of authentication with an iris image, for example, and descriptions thereof will be omitted in the present specification.

The storage section 7 is a recording medium storing information necessary for control at the control section 6 and is, for example, a flash memory. The type of the recording medium is not particularly limited.

Light emitted from the mobile information terminal 1A and light incident on the mobile information terminal 1A in taking an iris image of the user wearing the glasses with the mobile information terminal 1A having the above-described configuration will be briefly described below with reference to FIG. 2 again.

Since the user wears the glasses, there is a lens 10 of the glasses between an eyeball 20 of the user and the mobile information terminal 1A.

Normally, reflected light generated when near infrared light radiated to the eyeball 20 is reflected off an iris 21 is diffusely reflected light, and reflected light reflected off the lens 10 of the glasses is specularly-reflected light. The diffusely reflected light is assumed to lose polarization information on the incident light and to be in a substantially unpolarized state. On the other hand, the specularly-reflected light is not in an unpolarized state in accordance with the Fresnel equations.

The following happens especially under certain conditions. When the electric field of the incident light oscillates in a direction parallel with or perpendicular to the incident plane, in other words, when the direction of linear polarization is parallel with or perpendicular to the incident plane, the reflected light is linearly polarized with no change in the polarization direction.

The inventors have focused on the point that the relative positional relationship among the infrared light radiation section 4, an object to be irradiated (the iris 21, the lens 10 of the glasses), and the light-receiving section 5 (iris capturing camera) basically remains the same in a small information device, such as a smartphone, so that an incident plane unique for the device can be determined. Then, they arrived at an idea that a reflected-in image of a light source can be reduced by utilizing the above-described characteristics of reflection of polarized light.

Specifically, as described above, the mobile information terminal 1A of the present embodiment includes the linear polarizers disposed at the infrared light radiation section 4 and the light-receiving section 5. The transmission axis direction of the emitted-light polarizing filter 4a being the linear polarizer on the light source side is parallel with the arrangement direction D1. The transmission axis direction of the received-light polarizing filter 5a being the linear polarizer on the light-receiving section 5 side is orthogonal to the arrangement direction D1.

As illustrated in FIG. 2, unpolarized near infrared light L1 emitted from the infrared light source 4c passes through the emitted-light polarizing filter 4a, and at this time, is linearly polarized by the emitted-light polarizing filter 4a. Then, linearly polarized near infrared light L2 is emitted from the mobile information terminal 1A and is radiated to the lens 10. Near infrared light L3 reflected off the lens 10 in a specularly reflected manner and near infrared light L4 passing through the lens 10 and diffusely reflected off the iris 21 of the eyeball 20 are incident on the received-light polarizing filter 5a.

At this time, the oscillation direction of the electric field of the specularly-reflected near infrared light L3 (the direction of linear polarization) is orthogonal to the transmission axis of the received-light polarizing filter 5a. The near infrared light L3 is thus blocked by the received-light polarizing filter 5a. On the other hand, the substantially unpolarized near infrared light L4 is partially blocked by the received-light polarizing filter 5a, and near infrared light L5 passing through the received-light polarizing filter 5a is incident on the image pickup section 5c.

Note that FIG. 2 illustrates the state in which the iris 21 is not positioned on the optical axis of the light-receiving section 5; however, the same result can be obtained even with such a positional relationship that the iris 21 is positioned on the optical axis of the light-receiving section 5.

Even in the case where the user wears contact lenses instead of the glasses or no such eyewear, the near infrared light L2 is reflected off the contact lens or the cornea in a specularly reflected manner, so that a similar result can be obtained.

Details of Polarization Direction

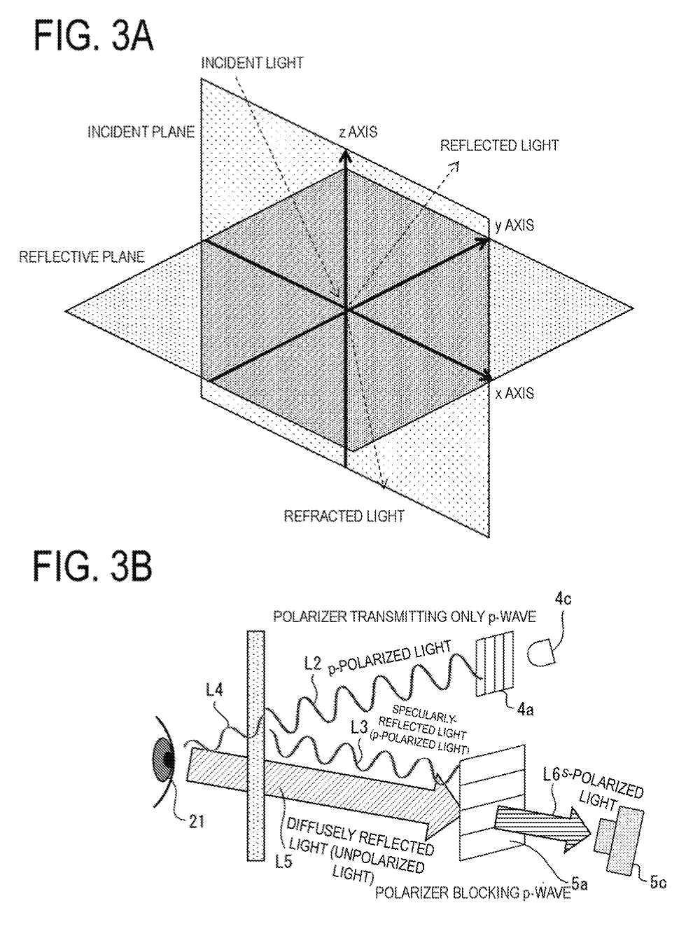

The above-described reflection and block of polarized light in the mobile information terminal 1A of the present embodiment will be described in detail below with reference to FIGS. 3A and 3B. FIG. 3A is a diagram for describing the incident plane and reflective plane of polarized light and polarization direction, and FIG. 3B is a schematic view for describing a positional relationship among the infrared light radiation section 4, the lens 10, and the light-receiving section 5, and the reflection and block of polarized light.

As illustrated in FIG. 3A, an x axis, a y axis, and a z axis orthogonal to each other are defined, and light is incident on the origin being the intersection of these axes. The plane containing the x axis and the y axis is the reflective plane. Herein, the reflective plane corresponds to the lens 10 of the glasses.

The near infrared light L2 emitted from the mobile information terminal 1A is assumed to be reflected off the lens 10 in a specularly reflected manner at an incident angle of greater than 0°. In this case, the plane orthogonal to the reflective plane and containing the optical axis of the incident light and the optical axis of the reflected light is defined as the incident plane.

In a case where incident light is linearly polarized in a direction parallel with the incident plane (in-plane direction) (in a case where the electric field oscillates only in the in-plane direction), the incident light is defined as p-polarized light. In a case where incident light is linearly polarized in a direction orthogonal to the incident plane (in a case where the electric field oscillates only in the orthogonal direction), the incident light is defined as s-polarized light.

There is such a property that, in a case where incident light is p-polarized or s-polarized, reflected light thereof is linearly polarized in the same direction as the incident light. In other words, in a case where the near infrared light L2 being incident light is p-polarized, the near infrared light L3 being reflected light thereof is also p-polarized. According to the Fresnel equations, reflectance of a mirror surface in p-polarization is known to be smaller than that in s-polarization. Thus, the near infrared light L2 being incident light is preferably p-polarized.

As illustrated in FIG. 3B, the mobile information terminal 1A of the present embodiment utilizes this property. In the mobile information terminal 1A, the near infrared light L3 reflected off the lens 10 in a specularly reflected manner is blocked by the received-light polarizing filter 5a, and part of the near infrared light L4 diffusely reflected off the iris 21 passes through the received-light polarizing filter 5a and is received by the image pickup section 5c.

In the present embodiment, the near infrared light L2 emitted through the emitted-light polarizing filter 4a is p-polarized. The near infrared light L3 generated when the near infrared light L2 is reflected off the lens 10 of the glasses in a specularly reflected manner is also p-polarized. The near infrared light L4 being the near infrared light L2 passing through the lens 10 refractively is radiated to the iris 21. The near infrared light L5 diffusely reflected off the iris 21 is in an unpolarized state. This near infrared light L5 passes through the lens 10 and is incident on the received-light polarizing filter 5a.

The received-light polarizing filter 5a having a transmission axis orthogonal to the emitted-light polarizing filter 4a blocks p-waves. The received-light polarizing filter 5a thus blocks the near infrared light L3. Part of the near infrared light L5 (unpolarized light) being diffusely reflected light passes through the received-light polarizing filter 5a and is linearly polarized. Linearly polarized near infrared light L6 (s-polarized light) is incident on the image pickup section 5c.

The above is achieved because the incident plane in taking an iris image with the mobile information terminal 1A can be determined depending on the positional relationship between the arrangement of the emitted-light polarizing filter 4a and the received-light polarizing filter 5a and the lens 10 of the glasses. In other words, the plane containing three points consisting of the point of emission of light from the emitted-light polarizing filter 4a, the point of incidence and reflection of light on the lens 10 (the origin in FIG. 3A), and the point of incidence of light on the received-light polarizing filter 5a is the incident plane.

Thus, the arrangement direction D1 of the emitted-light polarizing filter 4a and the received-light polarizing filter 5a coincides with the direction of p-polarization. Such an incident plane is determined regardless of the distance between the mobile information terminal 1A and the lens 10. The mobile information terminal 1A can thus reduce incidence of the near infrared light L3 reflected off the lens 10 in a specularly reflected manner on the image pickup section 5c regardless of the distance between the mobile information terminal 1A and the lens 10.

This positional relationship is maintained even with the mobile information terminal 1A inclined. Thus, even in a case where the user holds the mobile information terminal 1A while rotating the mobile information terminal 1A about an axis extending from the front of the terminal body 2 to the back, for example, incidence of the near infrared light L3 reflected off the lens 10 in a specularly reflected manner on the image pickup section 5c can be reduced. Similar effect is obtained even in a case where the user holds the mobile information terminal 1A while rotating the mobile information terminal 1A about an axis extending from above the terminal body 2 to below, for example.

Thus, with a simple configuration, the mobile information terminal 1A can prevent specularly-reflected light (the near infrared light L3) from the lens 10 from being incident on the image pickup section 5c and take an iris image with reduced reflection of the light source.

In contrast, in a case where the transmission axis direction of the emitted-light polarizing filter 4a is inclined with respect to the arrangement direction D1, that is, in a case where the linear polarization direction of the near infrared light L2 being incident light contains both the p-component and the s-component, the following problem arises.

That is, the reflected near infrared light L3 being specularly-reflected light has a ratio of the p-component and the s-component different from that of the near infrared light L2 being incident light. This is because the specular reflection is performed in accordance with the Fresnel equations. A different ratio of the p-component and the s-component of the specularly-reflected light (near infrared light L3) indicates that the direction of linear polarization also differs from that of the incident light (near infrared light L2).

The reflectance in the specular reflection differs between the p-component and the s-component and depends on the incident angle. Thus, the direction of linear polarization of the reflected light depends on the incident angle and varies depending on the distance between the light source and the person to be authenticated (the lens of the glasses). This indicates that the direction of linear polarization of the reflected light cannot be uniquely determined. Thus, in the case where the linearly polarization of the incident light contains both the p-component and the s-component, reflection of the light source may not be sufficiently removed in some cases.

### Advantage of Mobile Information Terminal of Present Embodiment

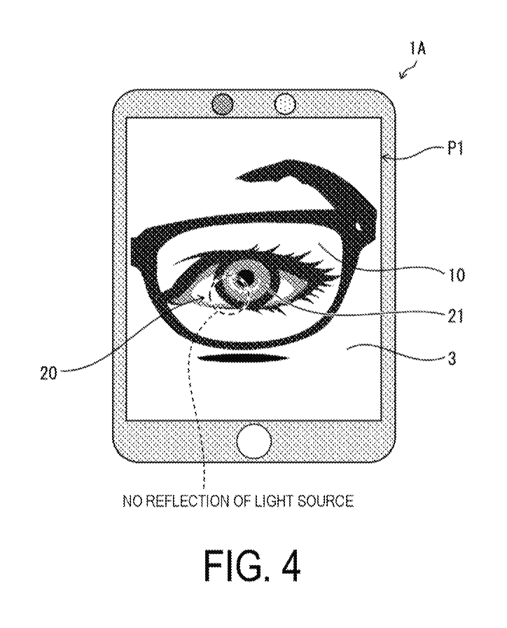

FIG. 4 is a schematic view of an image taken with the mobile information terminal 1A of the present embodiment.

In a case where the user wearing the glasses takes an image of the eyeball 20 with the mobile information terminal 1A, specularly-reflected light from the lens 10 is blocked by the received-light polarizing filter 5a and is not incident on the image pickup section 5c. Thus, as illustrated in FIG. 4, a displayed image P1 with no reflection of the light source is displayed on the display section 3. Consequently, a problem in authentication using the iris 21 is reduced.

In this way, the mobile information terminal 1A can take an iris image with reduced reflection of the light source with a simple configuration. Thus, the user can perform iris authentication without taking off the glasses, and a problem in iris authentication is difficult to arise. Consequently, convenience of the user can be significantly increased with a simple configuration.

### Modifications

(a) In the mobile information terminal 1A of Embodiment 1, the transmission axis direction of the emitted-light polarizing filter 4a is parallel with the arrangement direction D1, and the transmission axis direction of the received-light polarizing filter 5a is orthogonal to the arrangement direction D1.

An image pickup apparatus according to an aspect of the present disclosure is not necessarily limited to this configuration. Specifically, the angle of the transmission axis direction of the received-light polarizing filter 5a (the second direction) with respect to the transmission axis direction of the emitted-light polarizing filter 4a (the first direction) may be determined such that the received-light polarizing filter 5a blocks at least part of light having a polarization property in the reflected light (near infrared light L3).

In other words, the transmission axis direction of the emitted-light polarizing filter 4a may be shifted by a certain angle from the direction parallel with the arrangement direction D1. The transmission axis direction of the received-light polarizing filter 5a may be shifted by a certain angle from the direction orthogonal to the transmission axis of the emitted-light polarizing filter 4a.

Even with this configuration, the received-light polarizing filter 5a can partially block the near infrared light L3, resulting in a reduction in the amount of the near infrared light L3 incident on the image pickup section 5c. Thus, an iris image with reduced reflection of the light source can be taken with a simple configuration, which solves the problem in the related art.

(b) The transmission axis direction of the emitted-light polarizing filter 4a (the first direction) and the transmission axis direction of the received-light polarizing filter 5a (the second direction) are preferably orthogonal or substantially orthogonal to each other. The substantially orthogonal state will be described in detail below.

In a case where the first and second directions are orthogonal (completely orthogonal) to each other and the polarizing filters provide ideal performance, an iris image with no reflection of the light source at all can be taken. In other words, reflection of the light source in the iris image is perfectly removed.

In a case where the first and second directions are not completely orthogonal to each other, the following happens. The angle of a corner formed by intersection of the first direction and the second direction is deviated from 90°. The angle of this deviation is referred to as a deviation angle. In this case, it is expected that an increase in the deviation angle sinusoidally increases the amount of reflection of the light source in the iris image.

Slight reflection of the light source in the iris image may be allowed. That is, no problem arises with such reflection of the light source in the iris image that the amount of reflection of the light source does not cause any problem in iris authentication. Thus, the deviation angle may be allowed as long as no problem arise in iris authentication.

The allowable deviation angle can vary depending on various factors complicatedly. Examples of such factors include light source intensity, illumination in an image pickup environment, the distance between the eye and the terminal, the interval between the light source and the camera, performance of the authentication software, and the material (refractive index) of the lens. It is to be understood that specification of the substantially orthogonal state with a concrete numeric value is significantly difficult.

In a case where the transmission axis direction of the emitted-light polarizing filter 4a and the transmission axis direction of the received-light polarizing filter 5a are substantially orthogonal to each other, the received-light polarizing filter 5a can block the greater part of the near infrared light L3. Thus, the amount of the near infrared light L3 incident on the image pickup section 5c can be further reduced, resulting in a further reduction in the reflection of the light source.

(c) In the mobile information terminal 1A of Embodiment 1, the infrared light radiation section 4 and the light-receiving section 5 are disposed on the flat surface; however, no such limitation is intended. For example, in a mobile information terminal including an image pickup apparatus of the present disclosure, the infrared light radiation section 4 and the light-receiving section 5 may be disposed on a curved surface. Specifically, the curved surface may gently protrude with both ends of the mobile information terminal being the front side of the protrusion and the center of the terminal being the back side of the protrusion in a front view, for example. Alternatively, the mobile information terminal may be curved in a side view. Also in these cases, the arrangement direction D1 of the emitted-light polarizing filter 4a and the received-light polarizing filter 5a is the direction in which the emitted-light polarizing filter 4a and the received-light polarizing filter 5a are aligned when the emitted-light polarizing filter 4a and the received-light polarizing filter 5a are viewed from the front (front surface side).

(d) In the mobile information terminal 1A of Embodiment 1, the infrared light radiation section 4 and the light-receiving section 5 are disposed in the terminal body 2; however, no such limitation is intended. For example, one or both of the infrared light radiation section 4 and the light-receiving section 5 may protrude from the front surface of the terminal body 2. In this case, similar to Modification (c) above, the arrangement direction D1 and the transmission axis directions of the emitted-light polarizing filter 4a and the received-light polarizing filter 5a can be identified in projection on an assumed plane.

(e) An image pickup apparatus according to an aspect of the present disclosure can readily prevent reflection of the light source regardless of the arrangement of (distance between) the emitted-light polarizing filter 4a and the received-light polarizing filter 5a. Thus, the emitted-light polarizing filter 4a and the received-light polarizing filter 5a may be disposed apart from each other to some extent. For example, the infrared light radiation section 4 and the light-receiving section 5 may be disposed respectively at the left and right ends of the upper frame region A1.

Alternatively, the infrared light radiation section 4 and the light-receiving section 5 may be disposed respectively in the upper frame region A1 and a lower frame region on the side opposite to the upper frame region A1 across the display section 3. This configuration enables effective use of a space in the lower frame region.

### Embodiment 2

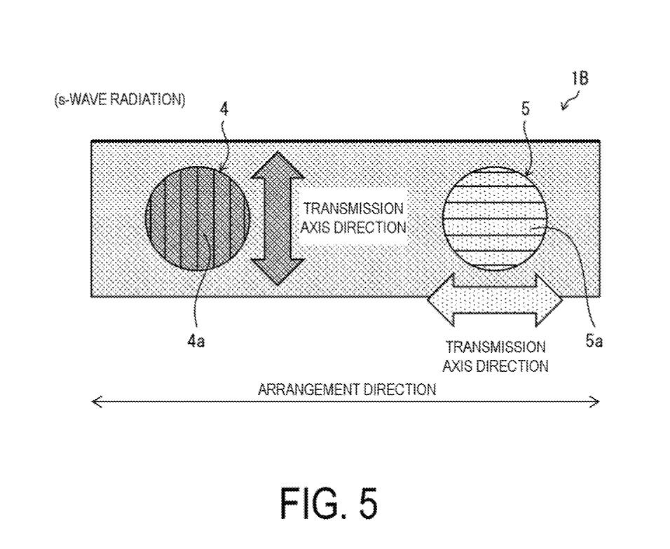

Another embodiment of the present disclosure will be described below with reference to FIG. 5. Note that, for convenience of description, components illustrated in Embodiment 1 are designated by the same reference numerals as those having the same function, and the descriptions of these components will be omitted.

In the mobile information terminal 1A of Embodiment 1, the transmission axis direction of the emitted-light polarizing filter 4a is parallel with the arrangement direction D1, and the transmission axis direction of the received-light polarizing filter 5a is orthogonal to the arrangement direction D1. With this configuration, the mobile information terminal 1A radiates the near infrared light L2 being p-polarized light. A mobile information terminal 1B of the present embodiment is different in that the transmission axis direction of the emitted-light polarizing filter 4a is orthogonal to the arrangement direction D1, and that the transmission axis direction of the received-light polarizing filter 5a is parallel with the arrangement direction D1.

FIG. 5 is an enlarged view of a main portion of the mobile information terminal 1B according to the present embodiment and illustrates the emitted-light polarizing filter 4a and the received-light polarizing filter 5a.

As described in Embodiment 1, when the direction of linear polarization is parallel with or perpendicular to the incident plane, the reflected light is linearly polarized with no change in the polarization direction. The mobile information terminal may thus have a configuration in which s-polarized light is radiated through the emitted-light polarizing filter 4a and the s-component is blocked by the received-light polarizing filter 5a.

In this case, as illustrated in FIG. 5, the transmission axis direction of the emitted-light polarizing filter 4a may be orthogonal to the arrangement direction D1, and the transmission axis direction of the received-light polarizing filter 5a may be parallel with the arrangement direction D1. This configuration enables radiation of s-polarized light through the emitted-light polarizing filter 4a to the lens 10 and the iris 21 (see FIG. 2). The received-light polarizing filter 5a blocks the s-component, resulting in a reduction in incidence of near infrared light reflected off the lens 10 in a specularly reflected manner on the image pickup section 5c.

### Embodiment 3

Still another embodiment of the present disclosure will be described below.

In the mobile information terminal 1A of Embodiment 1, the emitted-light polarizing filter 4a and the received-light polarizing filter 5a being polarizers are disposed in the terminal body 2. In a mobile information terminal 1C of the present embodiment, commercially available film-shaped polarizers may be adhered (attached externally) on the terminal body 2.

As an image pickup apparatus and the like according to an aspect of the present disclosure, an existing main body terminal, such as a smartphone, having an iris authentication function with the emitted-light polarizing filter 4a and the received-light polarizing filter 5a externally attached thereto is also within the scope of the present disclosure.

A sheet type resin polarizer, for example, is used as the polarizer on the light source side, enabling a simple configuration that can be manufactured at low cost. Similarly, a sheet type resin polarizer, for example, may be used as the polarizer on the camera side, if possible.

As described above, polarizers can be mounted in an existing mobile information terminal having an iris authentication function to manufacture a mobile information terminal according to an aspect of the present disclosure.

The emitted-light polarizing filter 4a and the received-light polarizing filter 5a are not required to be disposed on the same flat surface. For example, in an image pickup apparatus according to an aspect of the present disclosure, the emitted-light polarizing filter 4a may be an externally attached sheet type resin polarizer, and the received-light polarizing filter 5a may be a wire-grid polarizer disposed in the terminal body 2.

An image pickup method using the image pickup apparatuses in Embodiments 1 to 3 described above is summarized as below. The image pickup method takes an iris image with the image pickup apparatus including the infrared light source 4c emitting near infrared light and the image pickup section 5c receiving reflected light generated when the near infrared light is reflected off an object. The image pickup method includes emitting the near infrared light through the emitted-light polarizing filter 4a having a transmission axis in the first direction and receiving the reflected light through the received-light polarizing filter 5a having a transmission axis in the second direction different from the first direction. The angle of the second direction with respect to the first direction is determined such that the received-light polarizing filter 5a blocks at least part of light having a polarization property in the reflected light.

### Embodiment 4

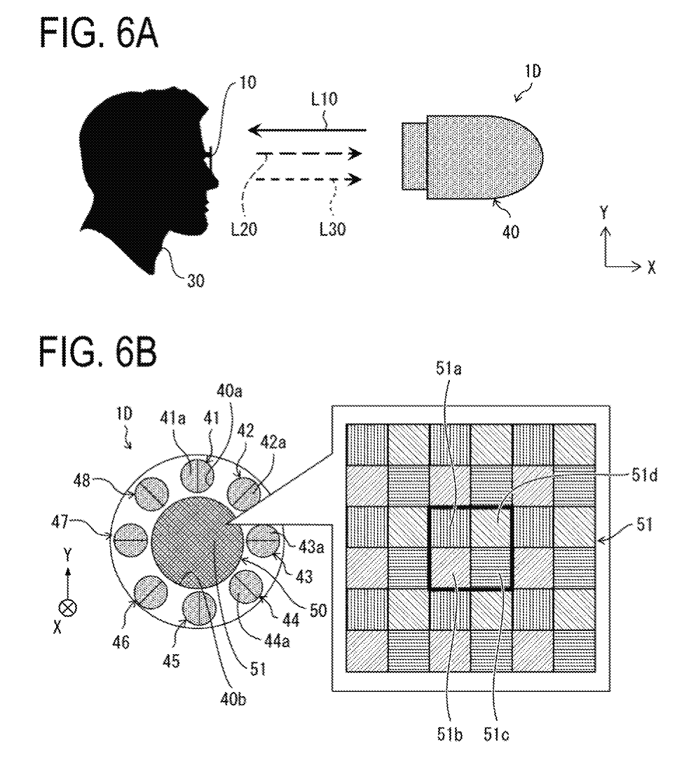

Still another embodiment of the present disclosure will be described below with reference to FIGS. 6 to 9. Note that a configuration other than that described in the present embodiment is the same as those of Embodiments 1 to 3. For convenience of description, components illustrated in Embodiments 1 to 3 are designated by the same reference numerals as those having the same function, and the descriptions of these components will be omitted.

The mobile information terminal 1A of Embodiment 1 is configured as a smartphone including a pair of the infrared light radiation section 4 and the light-receiving section 5. An iris authentication device 1D of the present embodiment is different in that the device includes eight light sources and a multi-polarizing filter (integrated polarizer) in which a large number of polarizing filters having four types of transmission axes are integrated.

The iris authentication device 1D is a small information device having a function to radiate near infrared light to an eyeball of a person and to take an image of an iris to perform iris authentication, and is used while being connected to, for example, a personal computer (PC).

Alternatively, the iris authentication device 1D may be disposed, for example, in the vicinity of a door or the like and used as a security facility determining whether a person can enter the door or the like.

The iris authentication device 1D can take an iris image with reduced reflection of the light sources. Especially, even in the case where a user wears glasses, reflection of the light sources can be reduced. Furthermore, an iris image can be taken with a greater amount of light.

### Configuration of Iris Authentication Device 1D

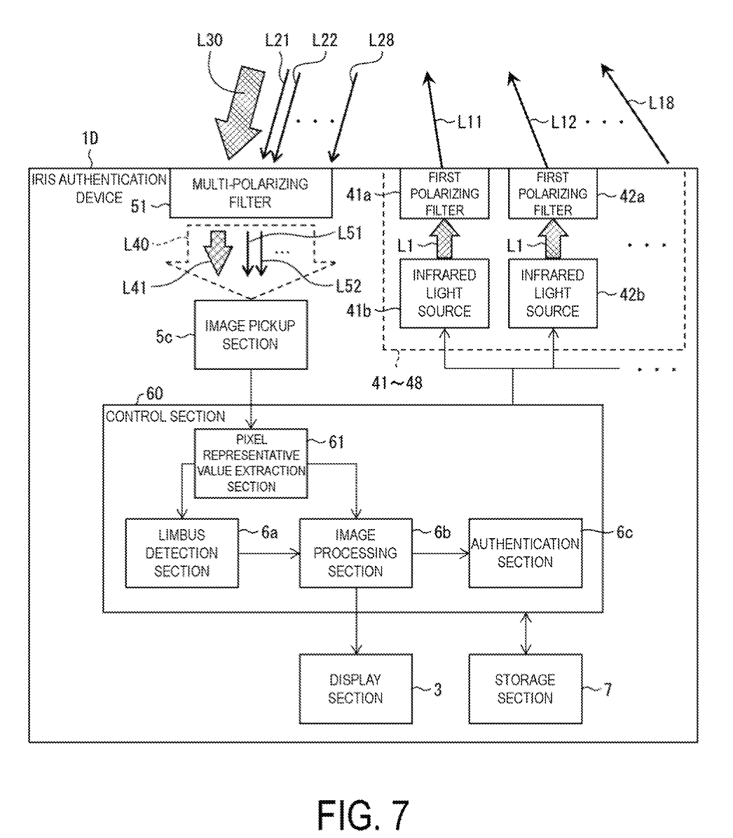

A configuration of the iris authentication device 1D including an image pickup apparatus and an authentication apparatus of the present embodiment will be described with reference to FIGS. 6 and 7. FIG. 6A is a side view of the state of taking an iris image with the iris authentication device 1D according to the present embodiment, and FIG. 6B is an enlarged view of a main portion. FIG. 7 is a schematic view of a configuration of the iris authentication device 1D. In the following description, the side where a user performs operations on the iris authentication device 1D (where the light sources and the multi-polarizing filter are disposed) is referred to as a front surface. An image of an iris of a user 30 wearing glasses is taken.

### External Structure

As illustrated in FIGS. 6A and 6B, the iris authentication device 1D includes a terminal body 40 being a housing, eight infrared light radiation sections 41 to 48, and a light-receiving section 50. The infrared light radiation sections 41 to 48 are disposed on the front surface side of the terminal body 40 while surrounding the light-receiving section 50 at regular intervals. The infrared light radiation sections 41 to 48 each include an infrared light source similar to that of the infrared light radiation section 4.

In the terminal body 40, emitting holes 40a from which the eight infrared light radiation sections 41 to 48 emit near infrared light are formed. The terminal body 40 also has an incident hole 40b that is formed at the center of the front surface and on which external light is incident to enter the iris authentication device 1D. The infrared light radiation sections 41 to 48 include the eight emitting holes 40a, and the light-receiving section 50 includes the incident hole 40b.

As illustrated in FIG. 6B, the infrared light radiation sections 41 to 44 include four types of first polarizing filters (first polarizing elements) 41a to 44a as linear polarizers. Note that the line drawn on each of the first polarizing filters 41a to 44a in the drawing indicates a transmission axis direction. The first polarizing filters 41a to 44a are similar to the emitted-light polarizing filter 4a of Embodiment 1.

In the drawing, +y axis direction of the y axis direction (the vertical direction in the plane of the paper) indicates an upper side. At the infrared light radiation section 41 disposed above the light-receiving section 50, the first polarizing filter 41a is disposed with its transmission axis extending in the vertical direction. The infrared light radiation section 45 having a transmission axis in the same direction is disposed on the side opposite to the infrared light radiation section 41 across the light-receiving section 50 (on a lower side).

The transmission axis direction of the first polarizing filter 41a is set to be a reference (0°). Clockwise from the infrared light radiation section 41, the infrared light radiation section 42, infrared light radiation section 43, and infrared light radiation section 44 being light sources are disposed, and include the corresponding first polarizing filters 42a, 43a, 44a having transmission axes in directions at angles of 45°, 90°, and 135°, respectively.

The infrared light radiation section 46, infrared light radiation section 47, and infrared light radiation section 48 having transmission axes in the corresponding same directions are disposed respectively on the sides opposite to the infrared light radiation section 42, infrared light radiation section 43, and infrared light radiation section 44 across the light-receiving section 50.

In other words, an arrangement direction being the direction of the straight line connecting the center of the emitting hole 40a and the center of the incident hole 40b is identified for each of the infrared light radiation sections 41 to 48. The first polarizing filters 41a to 48a are disposed at the infrared light radiation sections 41 to 48 so that the transmission axis directions are parallel with the respective arrangement directions.

That is, the polarizers are arranged so that light from the light sources of the infrared light radiation sections 41 to 48 is polarized in a direction parallel with the incident plane.

At the incident hole 40b of the light-receiving section 50, a multi-polarizing filter 51 is disposed. The multi-polarizing filter 51 is preferably disposed directly on the image pickup section 5c.

The multi-polarizing filter 51 of the present embodiment includes a plurality of polarizing units including four types of second polarizing filters (second polarizing elements) 51a to 51d (hereinafter referred to as polarizing filters 51a to 51d) having mutually different main axis directions. The polarizing units are arranged two-dimensionally. One polarizing unit corresponds to one pixel of an iris image, which will be described later. That is, the image pickup section (light-receiving unit) 5c includes light-receiving elements of which the number corresponds to the number of all the polarizing filters of the multi-polarizing filter 51.

As illustrated in FIG. 6B, the four types of polarizing filters 51a to 51d forming one polarizing unit have polarizing angles of 0°, 45°, 90°, and 135°, respectively. In other words, the four types of polarizing filters 51a to 51d have transmission axes in directions at angles of 0°, 45°, 90°, and 135°, respectively.

This indicates that the multi-polarizing filter 51 includes polarizing filters having transmission axes at a right angle to those of the polarizers disposed at the light sources (infrared light radiation sections 41 to 48).

The multi-polarizing filter 51 is required to enable this structure, and examples thereof include a wire grid made from metal, such as aluminum (A1), and an article including a photonic crystal in which materials having mutually different refractive indices are stacked.

The iris authentication device 1D of the present embodiment radiates near infrared light L10 from the infrared light radiation sections 41 to 48 to an eye of the user 30. Near infrared light L20 reflected off a lens 10 of the glasses in a specularly reflected manner and near infrared light L30 diffusely reflected off the iris of the user are incident on the multi-polarizing filter 51. In this iris authentication device 1D, an image of the iris of the user 30 is also taken at a relatively short distance from the user 30, so that the optical axis of the radiation light (near infrared light L10) is not assumed to coincide with the optical axis of the reflected light (near infrared light L20, L30).

### Internal Configuration, and Emission and Incidence and Selection of Light

Next, an internal configuration of the iris authentication device 1D of the present embodiment will be described with reference to FIGS. 6A and 6B and the block diagram in FIG. 7, and emitted light and incident light in taking an iris image and selection of light will be described. Note that in FIG. 7, for convenience of illustration, portions that are obvious even if omitted in the drawing are drawn in the dotted lines and are omitted as appropriate.

As illustrated in FIGS. 6A to 7, the iris authentication device 1D includes the infrared light radiation sections 41 to 48, the light-receiving section 50, a control section 60, the display section 3, and the storage section 7. The infrared light radiation sections 41 to 48 and the light-receiving section 50 constitute the image pickup apparatus of the present embodiment, and the image pickup apparatus and the control section 60 constitute the authentication apparatus of the present embodiment.

The infrared light radiation section 41 includes the first polarizing filter 41a and the infrared light source 41b emitting near infrared light. Similar to the infrared light source 4c of Embodiment 1, the infrared light source 41b is, for example, an LED.

Similarly, the infrared light radiation sections 42 to 48 each include the first polarizing filter and the infrared light source. Note that the infrared light radiation sections 41 to 48 may have a single common light source, for example. As such a light source, a surface emitting light source, for example, may be used.

The iris authentication device 1D illuminates the iris of the user with the infrared light sources 41b to 48b and can thus take a clearer iris image. On the other hand, reflection of the light sources may have a greater effect.

In the iris authentication device 1D of the present embodiment, the multi-polarizing filter 51 and a pixel representative value extraction section 61 of the control section 60 removes specularly-reflected light from the lens 10 of the glasses to prevent reflection of the light sources. The pixel representative value extraction section 61 and the image processing section 6b of the control section 60 constitute an image generation section of the present embodiment.

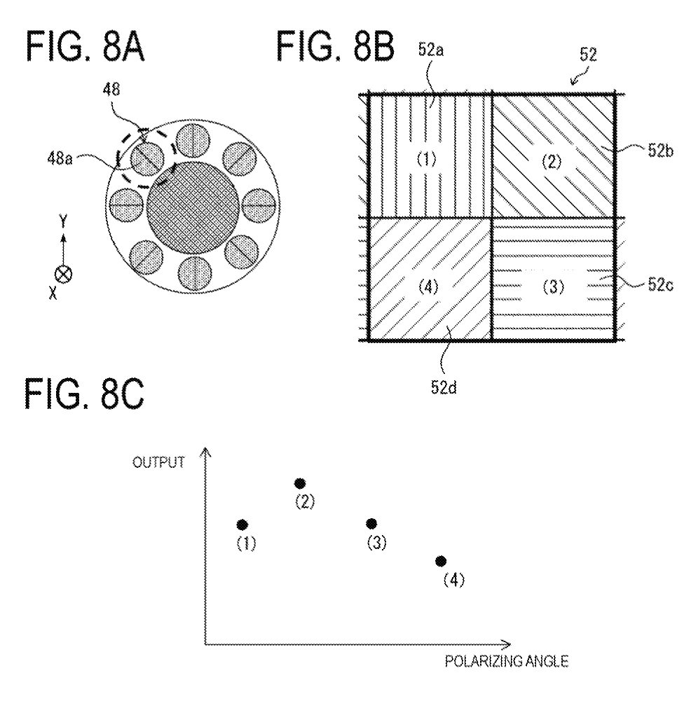

Operations of the pixel representative value extraction section 61 will be described below with reference to FIGS. 7 and 8. FIGS. 8A to 8C are diagrams for describing removal of specularly-reflected light in the iris authentication device 1D of the present embodiment. FIG. 8A is a front view of the iris authentication device 1D, FIG. 8B is an enlarged view of the polarizing unit 52, and FIG. 8C is a diagram for describing an example rule for extracting a pixel representative value.

As illustrated in FIG. 7, unpolarized near infrared light L1 is emitted from each of the infrared light sources 41b to 48b and is linearly polarized by the respective first polarizing filters 41a to 48a. Then, near infrared light L11 is emitted from the infrared light radiation section 41, and near infrared light L12 to L18 is emitted respectively from the infrared light radiation sections 42 to 48. Note that in FIG. 7, for convenience of illustration, portions having similar configurations are omitted as appropriate.

The near infrared light L11 to 18 is reflected off the lens 10 of the glasses, and near infrared light L21 to 28 being the reflected light is incident on the multi-polarizing filter 51. At the same time, the near infrared light L11 to 18 is diffusely reflected off the iris of the user 30, and near infrared light L30 being the diffusely reflected light is also incident on the multi-polarizing filter 51.

Near infrared light L40 from the multi-polarizing filter 51 is incident on the image pickup section 5c. This near infrared light L40 contains not only light (L41) passing through the multi-polarizing filter 51 in the near infrared light L30 being the diffusely reflected light but also the following light. That is, in the linearly polarized light (near infrared light L21 to 28) reflected off the lens 10 in a specularly reflected manner, light (near infrared light L51 to 58) passing through the polarizing filters other than the polarizing filters having transmission axes in the blocking directions of the linearly polarized light is contained. The blocking direction refers to a direction orthogonal to the polarization direction of each ray of the near infrared light L21 to 28 (linearly polarized light). The near infrared light L51 to 58 corresponds to the near infrared light L21 to 28. For example, the near infrared light L51 is light passing through the polarizing filters 51a, 51b, 51d in the near infrared light L21. This is because the polarizing filter 51c blocks the near infrared light L21.

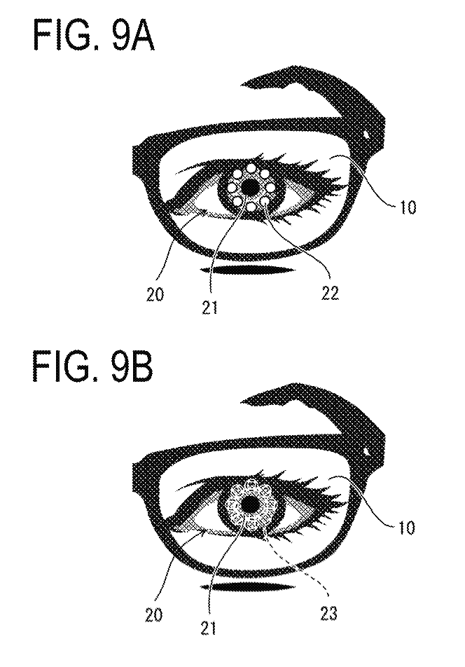

A specific example will be described below. Exemplified is the case in which light from the light source of the infrared light radiation section 48 illustrated in the dotted line in FIG. 8A is reflected off the lens 10 in a specularly reflected manner, and the specularly-reflected light is incident on the polarizing unit 52 illustrated in FIG. 8B. This polarizing unit 52 among a large number of the polarizing units of the multi-polarizing filter 51 is positioned in correspondence with the luminous point of the light source of the infrared light radiation section 48 among luminous points 22 (described later) illustrated in FIG. 9A.

The infrared light radiation section 48 includes the first polarizing filter 48a inclined at an angle of 135° with respect to the above-described reference (the transmission axis direction of the first polarizing filter 41a at an angle of 0°), and light emitted from the infrared light radiation section 48 is linearly polarized while being inclined at an angle of 135°.

The light passing through the polarizing unit 52 is received by photodiodes (light-receiving elements) of the CCD image sensor of the image pickup section 5c. Herein, the light is received by four photodiodes corresponding to the four types of polarizing filters 52a to 52d of the polarizing unit 52.

The pixel representative value extraction section 61 extracts an appropriate pixel representative value from four types of output from the four photodiodes. The extracted pixel representative value is used for subsequent processing at the limbus detection section 6a and the image processing section 6b.

FIG. 8C illustrates output values from the four photodiodes. Signs (1) to (4) in this drawing corresponds to those in FIG. 8B, and in specific, are output values of light passing through the polarizing filters 52a to 52d.

The transmission axis of the polarizing filter 52b (2) coincides with the polarization direction of the infrared light radiation section 48, so that the output value is maximum. In contract, the transmission axis of the polarizing filter 52d (4) coincides with the blocking direction, so that the output value is minimum. The polarizing filter 52a (1) and the polarizing filter 52c (3) provide intermediate values.

The specularly-reflected light is blocked, so that the output value of the polarizing filter 52d (4) contains only a diffuse reflection component including iris information. Thus, the minimum value is the pixel representative value for the polarizing unit 52. In this way, the minimum value is extracted for each of the polarizing units 52 to determine the representative value, so that the specular reflection components from the light sources can be removed, and a clear iris image can thus be taken.

Note that the multi-polarizing filter 51 may be an article like a photonic crystal instead of a metal grid, and is only required to be disposed on the image pickup device.

In this example, the number of the light sources is eight, and the number of the polarization directions is four. However, no such limitation is intended, of course, and such a configuration is only required that angles of the multi-polarizing filter coincide with the polarization directions of the light sources.

### Advantage of Iris Authentication Device of Present Embodiment

FIG. 9A is a schematic view of an image taken with an iris authentication device according to Comparative Example that does not remove specularly-reflected light, and FIG. 9B is a schematic view of an image taken with the iris authentication device 1D according to the present embodiment.

In a case where the user wearing the glasses takes an image of an eye with the iris authentication device of Comparative Example, light radiated from the infrared light radiation sections 41 to 48 is reflected off the lens 10 in a specularly reflected manner, and the display section displays a displayed image with eight luminous points 22 being reflection of the light sources.

In contrast, in a case where an image of the eye is taken with the iris authentication device 1D, the specularly-reflected light from the lens 10 is removed. Thus, as illustrated in FIG. 9B, reflection of the light sources at points 23 where the luminous points would appear is reduced.

In this way, the iris authentication device 1D can take an iris image with reduced reflection of the light sources with a simple configuration. Thus, the user can perform iris authentication without taking off the glasses, and a problem in iris authentication is difficult to arise. Consequently, convenience of the user can be significantly increased with a simple configuration.

### Modifications

(a) The infrared light radiation sections 41 to 48, that is, the first polarizing filters 41a to 48a are not required to be disposed surrounding the entire periphery of the light-receiving section 50. At least one of each of at least two types of first polarizing filters having transmission axes in mutually different directions is required to be disposed in the vicinity of the single light-receiving section 50.

(b) A plurality of first polarizing filters having a single common light source may be provided. The light source is not required to be provided in plurality.

### Implementation Example by Software

A control block (in particular, the pixel representative value extraction section 61) of the iris authentication device 1D may be realized by a logic circuit (hardware) formed by an integrated circuit (IC chip) and the like, or by software.

In the latter case, the iris authentication device 1D includes a computer executing commands of a program being software realizing the functions. This computer includes, for example, at least one processor and a computer-readable recording medium storing the program. In the computer, the processor reads the program from the recording medium and executes the program to achieve the object of the present disclosure. As the processor, a central processing unit (CPU) may be used.

As the recording medium, a “non-transitory tangible medium”, such as a read only memory (ROM), a tape, a disk, a card, a semiconductor memory, and a programmable logic circuit, may be used. A random access memory (RAM) in which the program is loaded may also be provided. Further, the program may be supplied to the computer via any transmission medium (a communication network, a broadcast wave, or the like) able to transmit the program. Note that an aspect of the present disclosure may be implemented in a form of data signals embedded in a carrier wave, which is embodied by electronic transmission of the program.

An image pickup apparatus (mobile information terminals 1A to 1C, iris authentication device 1D) according to Aspect 1 of the present disclosure includes: a first polarizing element (emitted-light polarizing filter 4a) having a transmission axis in a first direction; a second polarizing element (received-light polarizing filter 5a) having a transmission axis in a second direction different from the first direction; a light source (infrared light source 4c) configured to emit near infrared light through the first polarizing element; and a light-receiving element (image pickup section 5c) configured to receive reflected light generated upon reflection of the near infrared light off an object, through the second polarizing element. The second direction has such an angle determined with respect to the first direction that the second polarizing element blocks at least part of light having a polarization property in the reflected light.

With the above configuration, the near infrared light emitted through the first polarizing element and polarized in the first direction is reflected off, for example, a lens of glasses in a specularly reflected manner and is diffusely reflected off the iris of an eye of a user. An angle of the second direction being the transmission axis direction of the second polarizing element is determined such that at least part of the specularly-reflected light is blocked.

This configuration enables the second polarizing element to block at least part of the specularly-reflected light, and can thus increase a proportion of the diffusely reflected light from the iris and reduce a proportion of the specularly-reflected light from the lens or the like in the light received through the second polarizing element by the light-receiving element. Thus, with a simple configuration, the specularly-reflected light from the lens or the like can be prevented from being incident on the light-receiving element, and an iris image with reduced reflection of the light source can be taken.

In an image pickup apparatus according to Aspect 2 of the present disclosure, the first direction and the second direction are preferably substantially orthogonal or orthogonal to each other.

With the above configuration, in a case where the transmission axis direction of the first polarizing element is parallel with or perpendicular to the incident plane, for example, the near infrared light emitted through the first polarizing element and polarized in the first direction has a p- or s-wave. Such a p- or s-wave maintains its polarization direction even after specular reflection. Thus, with the first direction and the second direction forming an angle of 90°, the specularly-reflected light is blocked by the second polarizing element to a great extent. Consequently, with a simple configuration, the specularly-reflected light from the lens or the like can be prevented from being incident on the light-receiving element to a great extent, and an iris image with reduced reflection of the light source can be taken.

Note that the first direction and the second direction are not required to exactly form an angle of 90°, and may substantially form an angle of 90° as long as desired effect can be yielded.

In an image pickup apparatus according to Aspect 3 of the present disclosure, the first polarizing element and the second polarizing element are preferably aligned in an arrangement direction in a front view of the first polarizing element and the second polarizing element, and the first direction is preferably parallel with the arrangement direction.

With the above configuration, the near infrared light emitted through the first polarizing element and polarized in the first direction has a p-wave. The p-wave has lower specularly-reflected light intensity than s-waves, so that in this case, the intensity of the specularly-reflected light from the lens or the like is relatively low. Thus, an iris image with further reduced reflection of the light source can be taken.

An image pickup apparatus (iris authentication device 1D) according to Aspect 4 of the present disclosure includes: first polarizing elements (first polarizing filters 42a to 44a) of a plurality of types having transmission axes in mutually different directions; a light source (infrared light radiation sections 41 to 48) configured to emit near infrared light through the first polarizing elements; second polarizing elements (second polarizing filters 51a to 51d) of a plurality of types having transmission axes in directions corresponding to the directions of the transmission axes of the first polarizing elements; and a light-receiving element configured to receive reflected light generated upon reflection of the near infrared light off an object, through the second polarizing elements. The directions of the transmission axes of the second polarizing elements have such angles determined with respect to the directions of the transmission axes of the first polarizing elements that the second polarizing element of any one of the types blocks at least part of light having a polarization property in the reflected light.

With the above configuration, light is radiated from a plurality of light sources, so that a clearer iris image can be taken. At the same time, reflection of the used light sources in a displayed image can be reduced in taking the iris image.

An authentication apparatus according to Aspect 5 of the present disclosure includes: the image pickup apparatus according to any one of Aspects 1 to 4 described above; and an authentication section 6c configured to perform authentication using an iris image taken with the image pickup apparatus.

An authentication apparatus (iris authentication device 1D) according to Aspect 6 of the present disclosure may include: the image pickup apparatus according to Aspect 4 described above; and an authentication section 6c configured to perform authentication using an iris image taken with the image pickup apparatus. The image pickup apparatus may include: the polarizing units 52 including the second polarizing elements of a plurality of types; a light-receiving unit (image pickup section 5c) including a plurality of the light-receiving elements configured to receive light passing through the second polarizing elements in the polarizing units; and an image generation section (pixel representative value extraction section 61 and image processing section 6b) configured to generate the iris image using information on the light received by the light-receiving unit. The image generation section may be configured to generate the iris image using information on light received by the light-receiving element indicating a minimum light intensity between the light-receiving elements corresponding to each polarizing unit.

With the above configuration, near infrared light is radiated from a plurality of light sources, and reflected light is received by the second polarizing elements of the multiple types. Then, light passing through the second polarizing elements of the multiple types is received by the light-receiving unit including the light-receiving elements. The image generation section uses information on the light received by the light-receiving unit to generate the iris image. At this time, the image generation section uses information on light received by the light-receiving element indicating a minimum light intensity between the light-receiving elements of the light-receiving unit, to generate the iris image. This configuration can remove specularly-reflected light from the lens of the glasses or the like. Thus, a displayed image with no reflection of the light sources is displayed on a display section.

An image pickup method according to Aspect 7 of the present disclosure takes an iris image with an image pickup apparatus including a light source configured to emit near infrared light and a light-receiving element configured to receive reflected light generated upon reflection of the near infrared light off an object. The image pickup method includes: emitting the near infrared light through a first polarizing element having a transmission axis in a first direction; and receiving the reflected light through a second polarizing element having a transmission axis in a second direction different from the first direction. The second direction has such an angle determined with respect to the first direction that the second polarizing element blocks at least part of light having a polarization property in the reflected light.

The above configuration exhibits effect similar to that of an image pickup apparatus according to an aspect of the present disclosure.

The authentication apparatus according to each of Aspects of the present disclosure may be implemented by a computer. In this case, a control program for the authentication apparatus that causes the computer to function as each of the components (software modules) included in the authentication apparatus and a computer-readable recording medium storing the control program fall within the scope of the present disclosure.

The present disclosure is not limited to each of the above-described embodiments. It is possible to make various modifications within the scope of the claims. An embodiment obtained by appropriately combining technical elements each disclosed in different embodiments falls also within the technical scope of the present disclosure. Furthermore, technical elements disclosed in the respective embodiments may be combined to provide a new technical feature.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. An image pickup apparatus comprising:
a first polarizing element having a transmission axis in a first direction;
a second polarizing element having a transmission axis in a second direction different from the first direction;
a light source configured to emit near infrared light through the first polarizing element; and
a light-receiving element configured to receive reflected light generated upon reflection of the near infrared light off an object, through the second polarizing element;
the second direction having such an angle determined with respect to the first direction that the second polarizing element blocks at least part of light having a polarization property in the reflected light.

2. The image pickup apparatus according to claim 1, wherein the first direction and the second direction are substantially orthogonal or orthogonal to each other.

3. The image pickup apparatus according to claim 2, wherein:
the first polarizing element and the second polarizing element are aligned in an arrangement direction in a front view of the first polarizing element and the second polarizing element; and
the first direction is parallel with the arrangement direction.

4. An image pickup apparatus comprising:
first polarizing elements of a plurality of types having transmission axes in mutually different directions;
a light source configured to emit near infrared light through the first polarizing elements;
second polarizing elements of a plurality of types having transmission axes in directions corresponding to the directions of the transmission axes of the first polarizing elements; and
a light-receiving element configured to receive reflected light generated upon reflection of the near infrared light off an object, through the second polarizing elements;
the directions of the transmission axes of the second polarizing elements having such angles determined with respect to the directions of the transmission axes of the first polarizing elements that the second polarizing element of any one of the types blocks at least part of light having a polarization property in the reflected light.

5. An authentication apparatus comprising:
the image pickup apparatus according to claim 1; and
an authentication section configured to perform authentication using an iris image taken with the image pickup apparatus.

6. An authentication apparatus comprising:
the image pickup apparatus according to claim 2; and
an authentication section configured to perform authentication using an iris image taken with the image pickup apparatus.

7. An authentication apparatus comprising:
the image pickup apparatus according to claim 3; and
an authentication section configured to perform authentication using an iris image taken with the image pickup apparatus.

8. An authentication apparatus comprising:
the image pickup apparatus according to claim 4; and
an authentication section configured to perform authentication using an iris image taken with the image pickup apparatus.

9. An authentication apparatus comprising:
the image pickup apparatus according to claim 4; and
an authentication section configured to perform authentication using an iris image taken with the image pickup apparatus;
the light-receiving element comprising a plurality of light-receiving elements;
the image pickup apparatus comprising:
polarizing units comprising the second polarizing elements of a plurality of types;
a light-receiving unit comprising the plurality of light-receiving elements configured to receive light passing through the second polarizing elements in the polarizing units; and
an image generation section configured to generate the iris image using information on the light received by the light-receiving unit; and
the image generation section being configured to generate the iris image using information on light received by the light-receiving element indicating a minimum light intensity between the light-receiving elements corresponding to each polarizing unit.

10. An image pickup method taking an iris image with an image pickup apparatus comprising a light source configured to emit near infrared light and a light-receiving element configured to receive reflected light generated upon reflection of the near infrared light off an object, the image pickup method comprising:
emitting the near infrared light through a first polarizing element having a transmission axis in a first direction; and
receiving the reflected light through a second polarizing element having a transmission axis in a second direction different from the first direction;
the second direction having such an angle determined with respect to the first direction that the second polarizing element blocks at least part of light having a polarization property in the reflected light.

11. A non-transitory computer-readable recording medium recording an information processing program causing a computer to function as the authentication apparatus according to claim 9, the information processing program being configured to cause a computer to function as the image generation section.
